(19) United States
(12) Patent Application Publication
(10) Pub. No.: US 2022/0045582 A1
(43) Pub. Date: Feb. 10, 2022

(54) METHOD OF MANUFACTURING A THREE-DIMENSIONAL FLUX STRUCTURE FOR CIRCUMFERENTIAL FLUX MACHINES

(71) Applicant: Linear Labs, Inc., Fort Worth, TX (US)

(72) Inventors: Fred E. Hunstable, Granbury, TX (US); Michael Van Steenburg, Fort Worth, TX (US); Erik Hatch, Frisco, TX (US)

(21) Appl. No.: 17/393,600

(22) Filed: Aug. 4, 2021

Related U.S. Application Data
(63) Continuation of application No. PCT/US2020/018197, filed on Feb. 13, 2020.
(60) Provisional application No. 62/805,305, filed on Feb. 13, 2019.

(51) Int. Cl. H02K 15/02; H02K 1/14; H02K 1/20; H02K 21/14

(52) U.S. Cl. CPC H02K 15/022; H02K 1/145; H02K 2201/12; H02K 21/145; H02K 1/20

(57) ABSTRACT

Disclosed are various embodiments for assembling a new and improved electrical motor/generator, specifically a method of producing a coil assembly is disclosed comprising: pressing a plurality of individual teeth having interlocking side features, applying a conductor around one of the interlocking side features, coupling a tooth of the coil assembly with an adjacent tooth, applying a second conductor around one of the interlocking side features of the adjacent tooth, repeating the coupling and applying steps until an entire ring has been assembled.

### RELATED APPLICATIONS

This application is a continuation of International Application No. PCT/US2020/018197, filed Feb. 13, 2020, which claims the benefit of the filing date of U.S. provisional patent application Ser. No. 62/805,305, filed on Feb. 13, 2019, the disclosures of which are hereby incorporated by reference for all purposes.

This application is also commonly owned with the following U.S. applications: U.S. provisional patent application Ser. No. 62/167,412 entitled “An Improved Multi-Tunnel Electric Motor/Generator,” filed on May 28, 2015; and U.S. provisional patent application Ser. No. 62/144,654 entitled “A Multi-Tunnel Electric Motor/Generator,” filed on Apr. 8, 2015, the disclosures of which are hereby incorporated by reference for all purposes.

### TECHNICAL FIELD

The invention relates in general to a new and improved electric motor/generator, and in particular to an improved system and method for producing rotary motion from an electro-magnetic motor or generating electrical power from a rotary motion input.

### BACKGROUND INFORMATION

Electric motors use electrical energy to produce mechanical energy, very typically through the interaction of magnetic fields and current-carrying conductors. The conversion of electrical energy into mechanical energy by electromagnetic means was first demonstrated by the British scientist Michael Faraday in 1821 and later quantified by the work of Hendrik Lorentz.

In a traditional electric motor, a central core of tightly wrapped current carrying material creates magnetic poles (known as the rotor) spins or rotates at high speed between the fixed poles of a magnet (known as the stator) when an electric current is applied. The central core is typically coupled to a shaft which will also rotate with the rotor. The shaft may then be used to drive gears and wheels in a rotary machine and/or convert rotational motion into motion in a straight line.

Generators are usually based on the principle of electromagnetic induction, which was discovered by Michael Faraday in 1831. Faraday discovered that when an electrical conducting material (such as copper) is moved through a magnetic field (or vice versa), an electric current will begin to flow through that material. This electromagnetic effect induces voltage or electric current into the moving conductors.

Current power generation devices such as rotary alternator/generators and linear alternators rely on Faraday's discovery to produce power. In fact, rotary generators are essentially very large quantities of wire spinning around the inside of very large magnets. In this situation, the coils of wire are called the armature because they are moving with respect to the stationary magnets (which are called the stators). Typically, the moving component is called the armature and the stationary components are called the stator or stators.

In most conventional motors, both linear and rotating, enough power of the proper polarity must be pulsed at the right time to supply an opposing (or attracting) force at each pole segment to produce a particular torque. In conventional motors at any given instant only a portion of the coil pole pieces is actively supplying torque.

With conventional motors, a pulsed electrical current of sufficient magnitude must be applied to produce a given torque/horsepower. Horsepower output and efficiency then is a function of design, electrical input power plus losses.

With conventional generators, an electrical current is produced when the rotor is rotated. The power generated is a function of flux strength, conductor size, number of pole pieces and speed in RPM. However, output is a sinusoidal output which inherently has losses similar to that of conventional electric motors.

Specifically, the pulsed time varying magnetic fields produces undesired effects and losses, i.e. iron hysteresis losses, counter-EMF, inductive kickback, eddy currents, inrush currents, torque ripple, heat losses, cogging, brush losses, high wear in brushed designs, commutation losses and magnetic buffeting of permanent magnets. In many instances, complex controllers are used in place of mechanical commutation to address some of these effects.

Additionally, in motors or generators, some form of energy drives the rotation and/or movement of the rotor. As energy becomes more scarce and expensive, what is needed are more efficient motors and generators to reduce energy consumption, and hence costs.

### SUMMARY

In response to these and other problems, disclosed are various embodiments for assembling a new and improved electrical motor/generator, specifically a method of producing a coil assembly is disclosed comprising: pressing a plurality of individual coil segments having interlocking side features, applying a conductor around one of the interlocking side features, coupling a tooth of the coil assembly with an adjacent tooth, applying a second conductor around one of the interlocking side features of the adjacent tooth, repeating the coupling and applying steps until an entire ring has been assembled.

These and other features, and advantages, will be more clearly understood from the following detailed description taken in conjunction with the accompanying drawings. It is important to note the drawings are not intended to represent the only aspects of the invention.

### BRIEF DESCRIPTION OF THE DRAWINGS

FIG. 1 is an exploded view of one embodiment of a motor/generator component according to certain aspects of the present disclosure.

FIG. 2 is a detailed isometric view of a magnetic cylinder/stator element or magnetic cylinder/rotor element of the motor/generator component illustrated in FIG. 1.

FIG. 3 is an exploded view of the magnetic cylinder/stator element or the magnetic cylinder/rotor element of FIG. 2.

FIG. 4A is an isometric view of a partial coil assembly element.

FIG. 4B is a detailed perspective view of a single tooth or pole element of the partial coil assembly element illustrated in FIG. 4A.

FIG. 4C is a detailed perspective view of an alternative embodiment of a single tooth or pole element of the partial coil assembly element illustrated in FIG. 4A.

FIG. 4D is an isometric view of the partial coil assembly element of FIG. 4A coupled to a plurality of coil windings.

FIG. 4E is an isometric view of a coil assembly.

FIG. 5A is an isometric view illustrating an alternative embodiment of a single coil segment for a coil assembly.

FIG. 5B is an isometric view illustrating an alternative embodiment of a single coil segment for a coil assembly taken from another perspective.

FIG. 6 is an isometric view of the single coil segment of FIG. 5A coupled to a coil winding.

FIG. 7 is an isometric view of three coil segment coupled together.

FIG. 8A is an isometric view of several coil segment coupled together.

FIG. 8B is an isometric view of a completed coil assembly.

FIG. 9A is a top perspective view of an alternative embodiment of a coil segment.

FIG. 9B is a top perspective view of two coil segments.

FIG. 10A is a partial section view of the two coil segments of FIG. 9B

FIG. 10B is a partial section view of the two coil segments of FIG. 9B where the section cut is taken at a different location than that of FIG. 10A.

FIG. 11 is a partial section view of the two coil segments of FIG. 9B showing a flux path and current direction.

FIG. 12 is a partial section view of two coil segments for a linear machine.

### DETAILED DESCRIPTION

Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding conventional control circuitry, power supplies, or circuitry used to power certain components or elements described herein are omitted, as such details are within the skills of persons of ordinary skill in the relevant art.

When directions, such as upper, lower, top, bottom, clockwise, or counter clockwise are discussed in this disclosure, such directions are meant to only supply reference directions for the illustrated figures and for orientation of components in the figures. The directions should not be read to imply actual directions used in any resulting invention or actual use. Under no circumstances, should such directions be read to limit or impart any meaning into the claims.

Motor/Generator Element and Back Iron Circuit

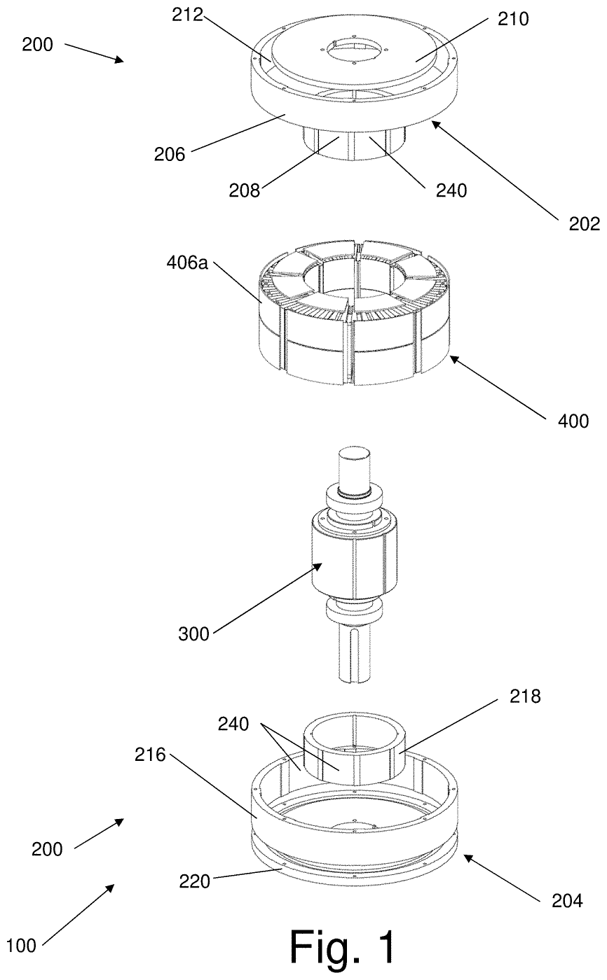

FIG. 1 is an exploded isometric view of a motor/generator element 100 illustrating a first portion 202 of a back iron circuit 200, a second portion 204 of the back iron circuit 200, a rotor hub 300, and a magnetic disc assembly 400.

The back iron circuit 200 is theoretically optional. It serves to strengthen magnetic elements (described below) and constrain the magnetic circuit to limit reluctance by removing or reducing the return air path. The first portion 202 of the back iron circuit 200 comprises a first outer cylindrical wall 206 made of a suitable back iron material. When the motor/generator element 100 is assembled, a first inner cylindrical wall 208 is concentrically positioned within the first outer cylindrical wall 206. A first flat side wall 210 which is also made of back iron material is positioned longitudinally next to the first outer cylindrical wall 206 and the first inner cylindrical wall 208.

A second portion of the back iron circuit includes a second inner cylinder wall 218 concentrically positioned within the second outer cylindrical wall 216 (when the motor/generator element 100 is assembled). A second flat side wall 220 of back iron material is positioned longitudinally next to the second outer cylindrical wall 216 and the second inner cylindrical wall 218. In certain embodiments, the second inner cylinder wall 218 and second outer cylinder wall 216 have a plurality of longitudinal grooves sized to accept and support a plurality of magnets as described below with respect to FIG. 1.

For purposes of this application the term “back iron” may refer to iron, any ferrous compound or alloy, such as stainless steel, any nickel or cobalt alloy, or any laminated metal comprising laminated sheets of such material.

In certain embodiments, there is a radial gap 212 between the first outer wall 206 and the first side wall 210. The radial gap 212 allows for the passage of a support structure, control wires and electrical conductors (not shown) into the magnetic disc assembly 400 as well as for heat dissipation or a thermal control medium. In other embodiments, the gap 212 may be defined within the first outer wall 206 or between the first outer wall 206 and the second outer wall 216.

In certain embodiments, a plurality of surface grooves 240 are defined and radially spaced around an inner surface of the first outer cylinder wall 206 or cylinder wall 216. Similarly, the plurality of surface grooves 240 are defined and radially spaced around an outer surface of the first inner cylinder wall 208 or inner cylinder wall 218.

As will be described in detail below, a plurality of outer magnets forming a portion of an outer magnetic wall 406a (from the magnetic disc 400 discussed below) may be sized to fit within the plurality of surface grooves 240. Similarly, a plurality of inner magnets forming a portion of an inner magnetic wall 408a are sized to fit within the plurality of surface grooves 240 defined within the outer surface of the first inner cylinder wall 208. In certain embodiments, the magnets forming the magnetic walls may be glued or epoxied to the grooves 240. In yet other embodiments, the magnets may be just positioned and glued or epoxied against the appropriate surface of the back iron component.

Thus, when the motor/generator element 100 is assembled, the first portion 202 of the back iron circuit and the second portion 204 of the back iron circuit physically support and surround the magnetic disc 400. The first inner wall 208 and second inner wall 218 also radially surrounds and is radially coupled to the rotor hub 300. In certain embodiments, the rotor hub 300 positions and structurally supports certain components of the back iron circuit 200 (which in turn, supports the magnetic components of the magnetic disc 400), which may act as a rotor.

Magnetic Disc Assembly

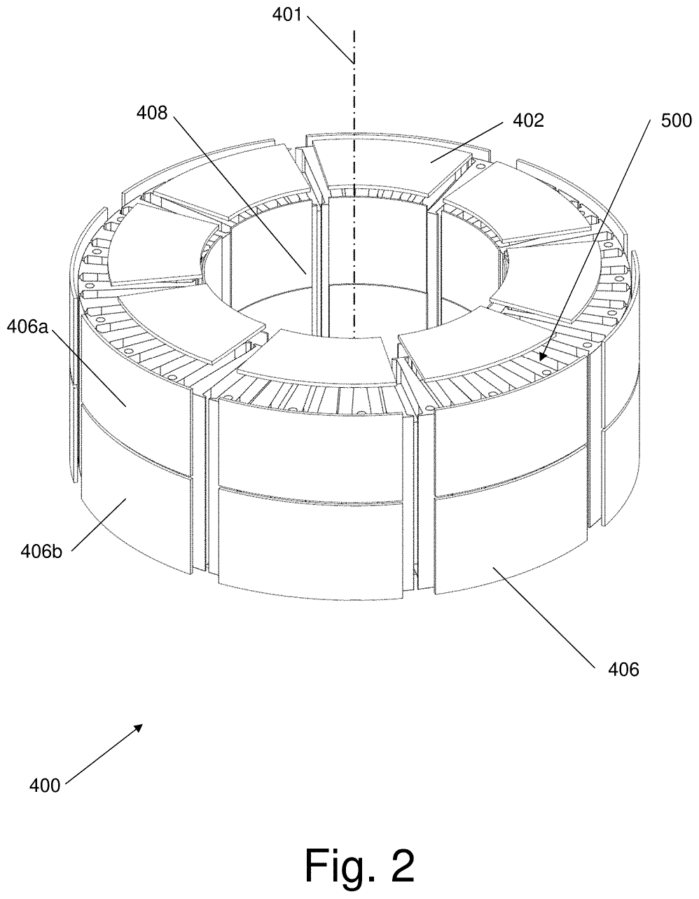

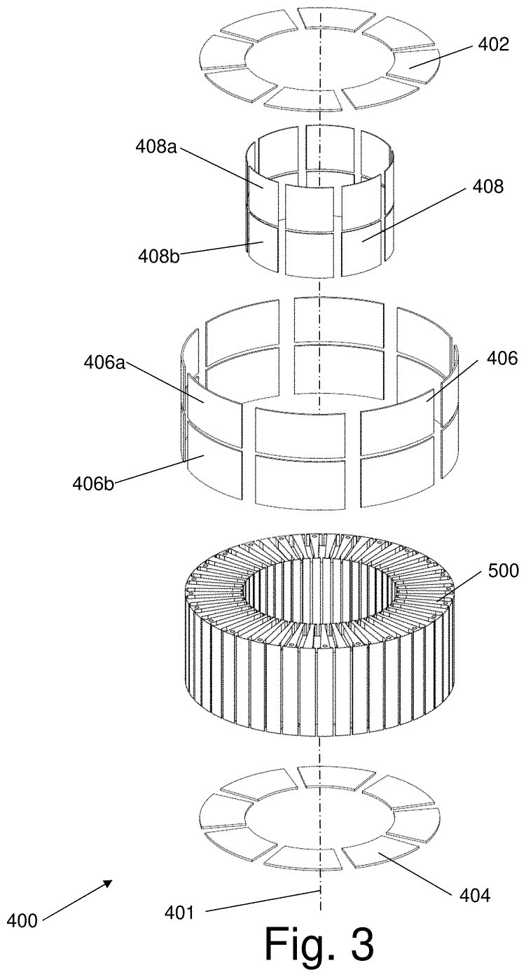

FIG. 2 is a detailed isometric view of the assembled magnetic disc 400 (with the back iron portions 202 and 204 removed for clarity) to show the magnets forming the magnetic walls. FIG. 3 is an exploded view of the magnetic disc 400. In the embodiment illustrated in FIGS. 2 and 3, with respect to an axial or longitudinal axis 401, there is a top or first axial or side wall of magnets 402. Similarly there is a bottom or second axial or side wall of magnets 404. An outer cylindrical wall of magnets 406 is longitudinally positioned between the first axial or side wall 402 and the second axial or side wall of magnets 404. In certain embodiments, the outer cylindrical wall of magnets 406 comprises two pluralities of magnets 406a and 406b which are sized to couple with the back iron walls 206 and 216, as described above with respect to FIG. 2.

An inner cylindrical wall of magnets 408 is also longitudinally positioned between the first axial or side wall 402 and the second axial or side wall of magnets 408 and concentrically positioned within the outer cylindrical wall of magnets 406. In certain embodiments, the inner cylindrical wall of magnets 408 comprises two pluralities of magnets 408a and 408b which are sized to couple with the back iron walls 208 and 218, as described above in reference to FIG. 2.

In certain embodiments, the magnets forming the axial side walls 402-404 and cylindrical walls 408-406 discussed herein may be made of out any suitable magnetic material, such as: neodymium, Alnico alloys, ceramic permanent magnets, or electromagnets. The exact number of magnets or electromagnets will be dependent on the required magnetic field strength or mechanical configuration. The illustrated embodiment is only one way of arranging the magnets, based on certain commercially available magnets. Other arrangements are possible, especially if magnets are manufactured for this specific purpose.

Coil Assembly

A coil assembly 500 is concentrically positioned between the outer cylinder wall 406 and the inner cylinder wall 408. The coil assembly 500 is also longitudinally positioned between the first axial magnetic wall 402 and the second axial magnetic wall 404. In certain embodiments, the coil assembly 500 may be a stator. In yet other embodiments, the coil assembly 500 may be a rotor.

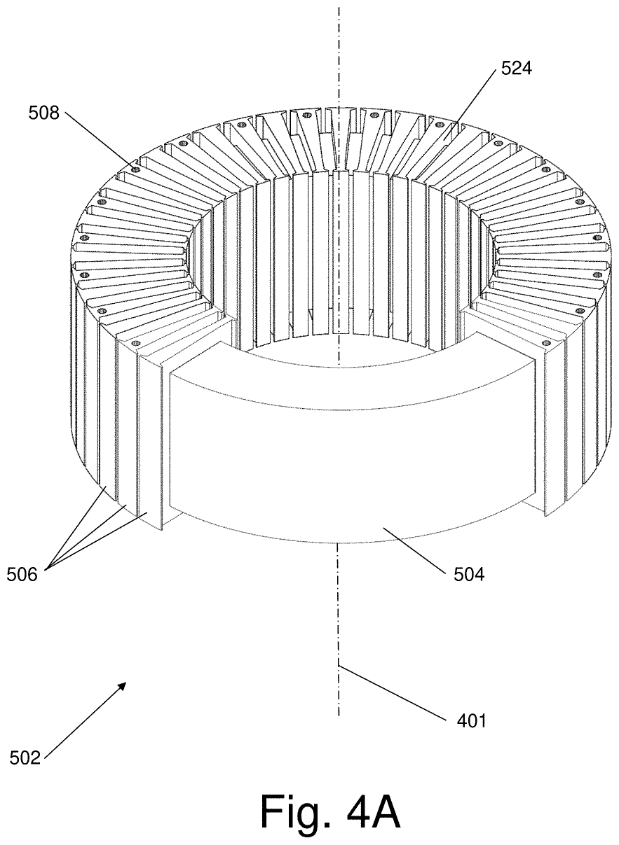

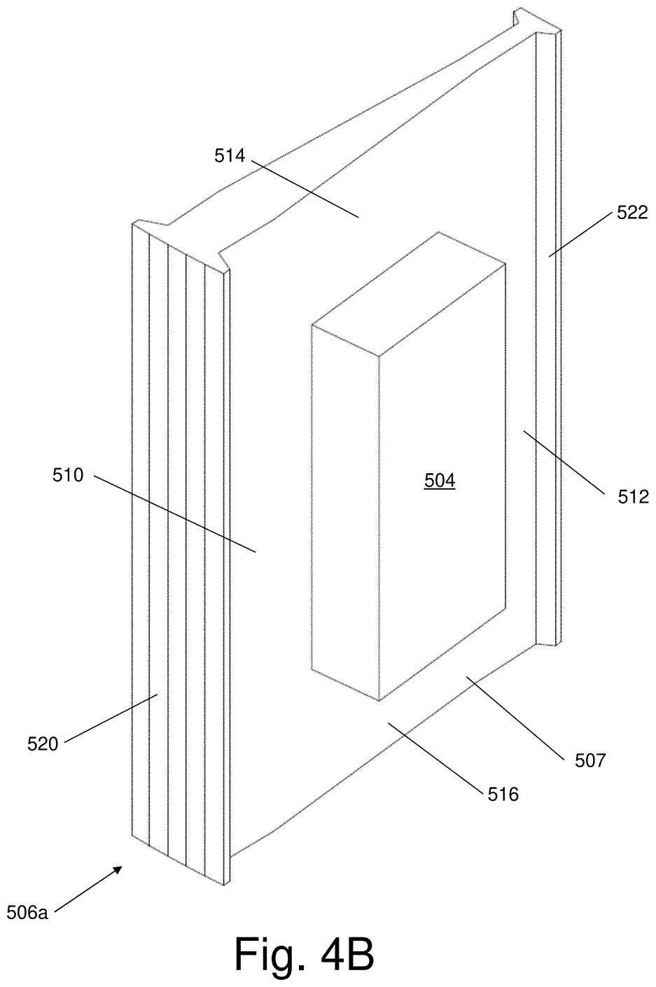

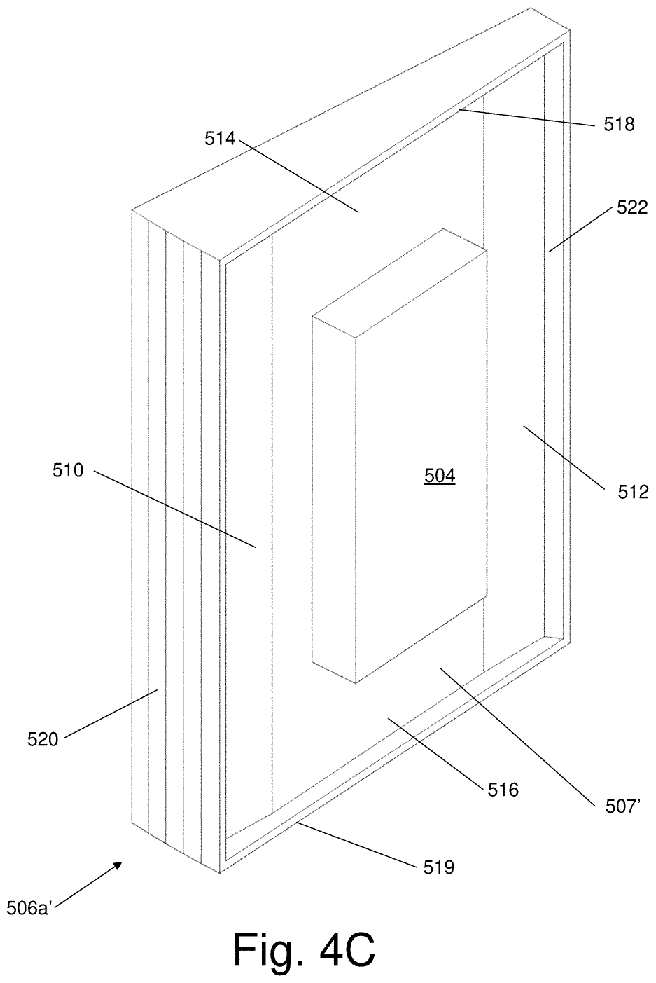

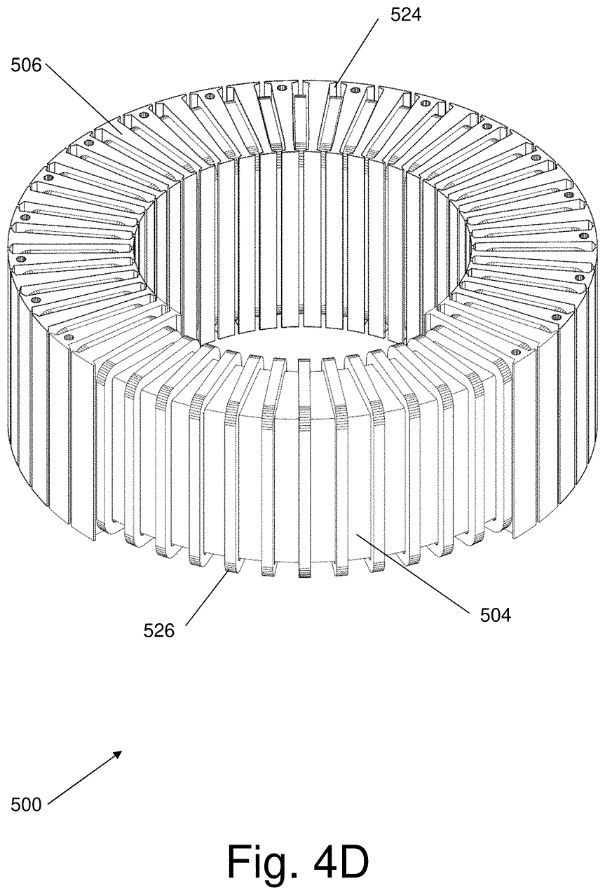

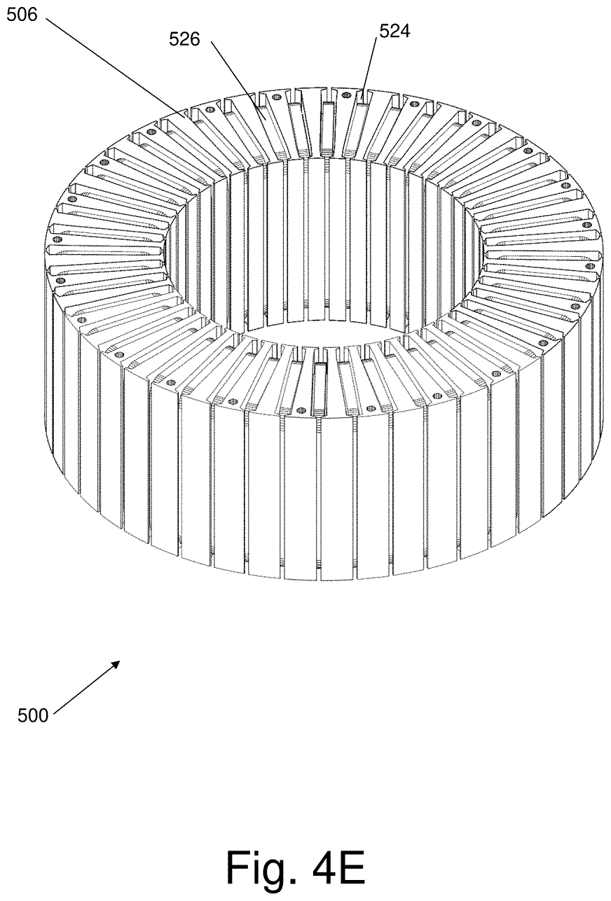

Turning now to FIG. 4A, there is an isometric view of a coil assembly support 502, which in one embodiment, may be a portion of a stator used in conjunction with a rotor formed by the magnetic axial walls 402-404 and magnetic cylinder walls 406-408 and the back iron circuit portions 202 and 204 discussed above. In certain embodiments, the coil assembly support 502 comprises a ring core or yoke 504 coupled to a plurality of teeth or in some embodiments, “stator poles” 506 radially spaced about the ring core or yoke 504. FIG. 4A shows a portion of stator poles 506 removed so that the ring core or yoke 504 is visible.

In certain embodiments, the ring core or yoke 504 and coil assembly support 502 may be made out of iron or back iron materials so that it will act as a magnetic flux force concentrator. However, other core materials maybe used when design considerations such as mechanical strength, reduction of eddy currents, cooling channels, etc. are considered. As discussed above, back iron materials may be an iron alloy, laminated metal, iron, or a sintered specialty magnetic powder. In some embodiments, the ring core 504 may be hollow or have passages defined therein to allow for liquid or air cooling.

In yet other embodiments, the coil assembly support 502 may be made from a composite material which would allow it to be sculptured to allow for cooling and wiring from inside. The composite material may be formed of a “soft magnetic” material (one which will produce a field magnetic field when current is applied to adjoining coils). Soft magnetic materials are those materials which are easily magnetized or demagnetized. Examples of soft magnetic materials are iron and low-carbon steels, iron-silicon alloys, iron-aluminum-silicon alloys, nickel-iron alloys, iron-cobalt alloys, ferrites, and amorphous alloys.

In yet other embodiments, a powdered metal, such as Somaloy 7003P may be used to form the coil assembly support 502. Somaloy 7003P is not sintered, but heat treated in a steam oxygen environment which causes its particles to bond when exposed to high pressure, such as 50 tons per square inch.

In certain embodiments, the wiring connection can also be formed in the shape of a plug in a modular assembly for the stator teeth or poles. Thus, certain poles of the plurality of teeth or poles 506 may have holes 508 adapted to accommodate such plugs (or wires) defined on one side of the coil assembly 502 for attachment to a structural support in embodiments where the coil assembly 500 acts as a stator.

A portion of the coil assembly is illustrated in FIG. 4B as a stator segment 506a. The stator segment 506a comprises a portion of the stator core or yoke 504 and a pole 507. In the illustrated embodiment, the pole 507 extends from the ring core 504 in radial and vertical (or axial) directions. Thus, each pole 507 comprises an outer radial portion 510 extending radially away from the axial or longitudinal axis 401 (see FIG. 4A), an inner radial portion 512 extending radially toward the longitudinal axis 401, a top vertical or longitudinal portion 514 extending in one vertical or axial direction, and a bottom vertical or longitudinal portion 516 extending in the opposing axial or longitudinal direction. The ring core 504 positions and supports the individual tooth or pole 507 as well as other teeth as described above in reference to FIG. 4A.

An exterior fin 520 couples to an exterior portion of the outer radial portion 510 and extends outward from the outer radial portion 510 in a circumferential direction with respect to the axial axis 401. Similarly, an interior fin 522 couples to an interior portion of the inner radial portion 512 and extends outward from the inner radial portion 512 in a circumferential direction. In certain embodiments, when the motor 100 is assembled the exterior fin 520 is positioned adjacent to the cylindrical magnetic wall 406 (see FIG. 2 or FIG. 3). Similarly, the interior fin 522 is positioned adjacent to the cylindrical magnetic wall 408. Thus, when magnetic walls 406 and 408 rotate relative to the fins 520 and 522, magnetic flux through the pole 507 from the fins 520 and 522.

An alternative embodiment of stator portion 506a having an individual tooth or pole 507′ and a small portion of the ring core 504 is illustrated in FIG. 4C. The pole 507′ is similar to the pole 507 described above in reference to FIG. 4B except that the pole 507′ also has radial or horizontal fins extending circumferentially from the top vertical portion 514 and the lower vertical portion 516. Specifically, a top radial fin 518 extends in a circumferential (or tangential) direction from the top horizontal portion 514 and connects the exterior fin 520 to the interior fin 522. Similarly, a second radial fin 519 extends in a circumferential direction from the lower vertical or opposing portion 516 and also connects the exterior fin 520 to the interior fin 522 as illustrated in FIG. 4C.

In certain embodiments, when the motor 100 is assembled the radial fin 518 is positioned adjacent to the axial magnetic wall 402 (see FIG. 2 or FIG. 3). Similarly, the radial fin 519 is positioned adjacent to the cylindrical magnetic wall 404. Thus, when magnetic walls 402 and 404 rotate relative to the fins 518 and 519, magnetic flux runs through the pole 507 from the fins 518 and 519.

Adjacent teeth or poles 507 (or adjacent teeth 507′) supported by the core ring 504 form radial slots 524 within the coil assembly support structure 502, as illustrated in FIG. 4A. A plurality of coils or coil windings 526 may be positioned radially about the ring core 504 and within the slots 524 as illustrated in FIG. 4D. FIG. 4D illustrates the plurality of coil windings 526 distributed about the coil support assembly 502 with a number of teeth 506 removed for clarity. In contrast, FIG. 4E illustrates a complete coil assembly 500 showing all of the teeth 506 and coil windings 526 positioned within the slots 524.

Coils or Coil Windings

Each individual coil 526 in the coil assembly 500 may be made from a conductive material, such as copper (or a similar alloy) wire and may be constructed using conventional winding techniques known in the art. In certain embodiments, concentrated windings may be used. In certain embodiments, the individual coils 526 may be essentially cylindrical or rectangular in shape being wound around the ring core 504 having a center opening sized to allow the individual coil 526 to surround and be secured to the ring core 504. Thus, in such embodiments, the winding does not overlap.

By positioning the individual coils 526 within the slots 524 defined by the pole 507 or 507′, the coils are surrounded by the more substantial heat sink capabilities of the teeth. In certain embodiments, the teeth and or ring core 504 can incorporate cooling passages directly into the material forming the teeth. This allows much higher current densities than conventional motor geometries. Additionally, positioning the plurality of coils 526 within the slots 524 and between teeth 506 reduces the air gap in the magnetic flux path between the coils and the magnets of the adjacent magnetic walls. By reducing the air gap, the coil assembly 500 can contribute to the overall torque produced by the motor or generator.

In certain embodiments, the horizontal fins 518 and 519, the circumferential fins 520 and 522 of the teeth 506a or 506a′ of the coil assembly reduce the air gaps between the magnetic material and the coil structure to allow flux forces to flow in the proper direction when the coils are energized and the coil assembly 500 begins to move relative to the magnetic tunnel. Thus, all portions of the coil support assembly 502 contribute to the overall torque developed by the system.

The windings of each coil 526 are generally configured such that they remain transverse or perpendicular to the direction of the relative movement of the magnets (e.g. the tangential direction) comprising the coil assembly 500 and parallel with the longitudinal axis 401. In other words, the coil windings are positioned such that their sides are parallel with the longitudinal axis 401 and their ends are radially perpendicular to the longitudinal axis.

In sum, the windings are placed in an axial/radial direction in multiple slots 524 (e.g. 48 slots) which can form a phase winding. The radial/axial placement of the windings may create a maximum force in the direction of motion for all four sides of the windings.

Using essentially four rotors and fins on each tooth or pole adjacent to each rotor creates a more efficient design because the air gap in the flux path is reduced. Unfortunately, the fins may complicate the fabrication of the coil windings because if the coil assembly is fabricated as a single piece, the fins will get in the way of the coil winding process—thereby increasing the motor costs. So, unconventional fabrication and winding techniques may be used when using such fins—such as fabricating the coil assembly support 502 in conjunction with the coil windings as described below.

Method of Manufacturing:

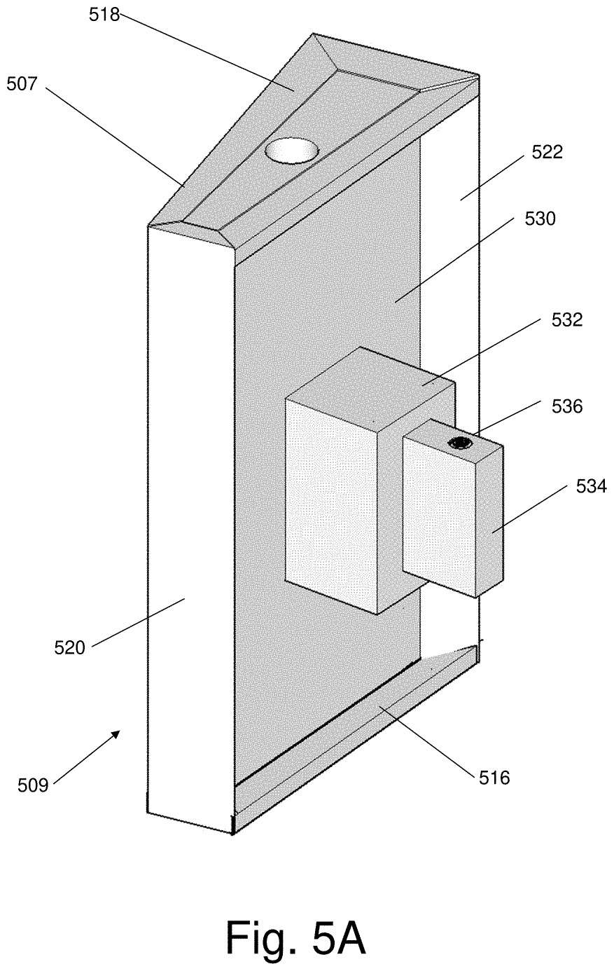

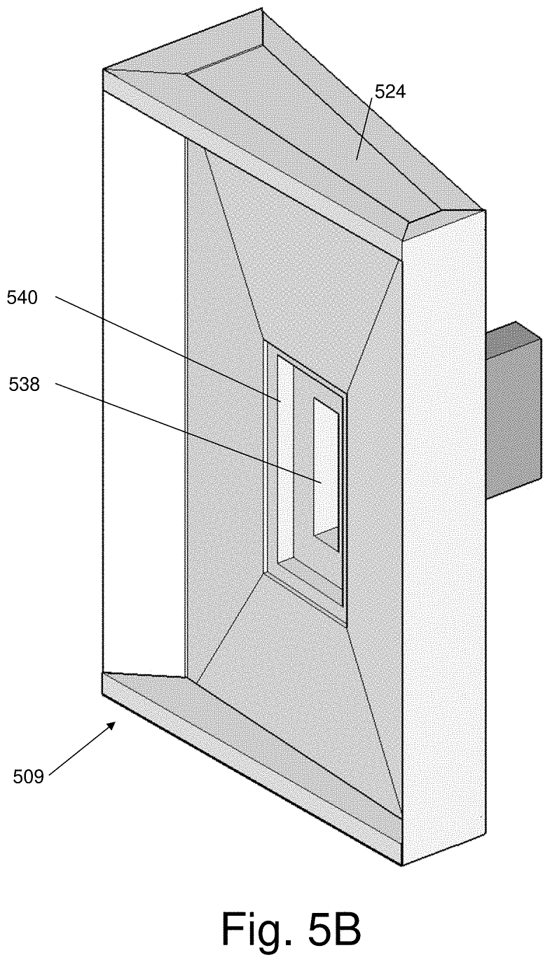

In certain embodiments, the coil assembly 502 may be formed by coupling or gluing a plurality of individual coil segments together to form an entire ring-like coil assembly support 502. In such an embodiment, each individual segment may have an interlocking nib or connector on one side of the segment as illustrated in FIGS. 5A and 5B. In FIGS. 5A and 5B, there is presented a modular coil segment 509 containing a tooth or pole 507. FIG. 5A is a right front isometric view of the coil segment 509 as would be seen from the interior of the coil assembly 502. FIG. 5B is a left front isometric view of the coil segment 509.

As illustrated in FIGS. 5A and 5B, the pole 507 is similar to the pole 506a and 506a′, except the pole 507 is formed as an individual pole of a modular coil segment 509 and not integral with the entire ring core 504 as illustrated in FIG. 4A. As illustrated, projecting from the face or surface 530 of the pole 507, is a first protrusion 532. In the illustrative embodiment, the protrusion 532 is a rectangular protrusion, but the protrusion could be any shape. Projecting from the protrusion 532 is a second and smaller protrusion 534. In certain embodiments, there may be a screw hole 536 defined within a surface of the small protrusion 534 to mate with a locking mechanism (not shown in FIG. 5A.).

In certain embodiments, the small protrusion 534 is sized to mate with an opening 538 of the adjacent coil segment 509 as illustrated in FIG. 5B. In certain embodiments, a larger opening 540 may be defined within a face of the adjacent coil segment 509 to accommodate the larger protrusion 532. In yet other embodiments, the protrusions 532 and 534 and the corresponding openings 536 and 538 may be replaced by interlocking nibs projecting from both faces.

In certain embodiments, the coil segment 509 may be forged as a single piece. As previously discussed, in certain embodiments, powdered metal, such as Somaloy 7003P may be used to form the coil assembly support 502. As previously discussed, powdered metals, such as Somaloy 7003P are solidified by first pressing the resin surrounding the particles together with high pressures, such as 50 tons per square inch pressure. Thus, the larger the surface area of the part is, the more compression is needed.

In this embodiment, the individual coil segment 509 illustrated in FIG. 5A may be formed from pressing a powdered metal into the appropriate shaped mold. For instance, powered metals, such as Somaloy 7003P, may be pressed at a high pressure to form the coil segment 509. Once the segment is pressed, the segment is heat-treated in a nitrogen steam environment which causes the resin coatings on the powdered metal to be oxygenated together and provides strength for the segment. Thus, there is an external layer on the particles that are then oxidized together. After heat treatment, any remaining slag can be removed by sandblasting or other techniques known in the art.

Using such powdered metal provides an electrically resistant material because each particle is essentially coated with an insulating or oxidized material. In other embodiments, iron particles may be mixed with a low melting point epoxy. In such an environment, once the iron/epoxy solution is heated (e.g., 105 degrees), the epoxy turns to liquid and the applied pressure can bleed the epoxy out of the mold—leaving almost pure iron.

In yet, other embodiments, the segments may be made of laminated metal. When using laminated metal, the flux can be controlled as the flux will only enter from a direction that is in parallel to the laminations and not transverse to the laminations. Thus, it is possible to specifically control the flux path based on the orientation of the laminations. It is also possible to turn off different areas of the lamination to obtain specific control for the flux path. Turning back to FIG. 5A, for instance, it is possible that the pole portions 510, 512, 514 and 516 be made of laminated sections where the laminations are parallel to the face 530 of the pole. The flux will then easily flow to or from the center of the segment. On the other hand, if the yoke or core protrusion 532 was also made of laminated metal with the laminations running parallel to the face 530 of the pole, the flux would not flow easily through the core or yoke. In other embodiments, the laminations could either end at the yoke or be bent so that the laminations going through the yoke run in a circumferential direction.

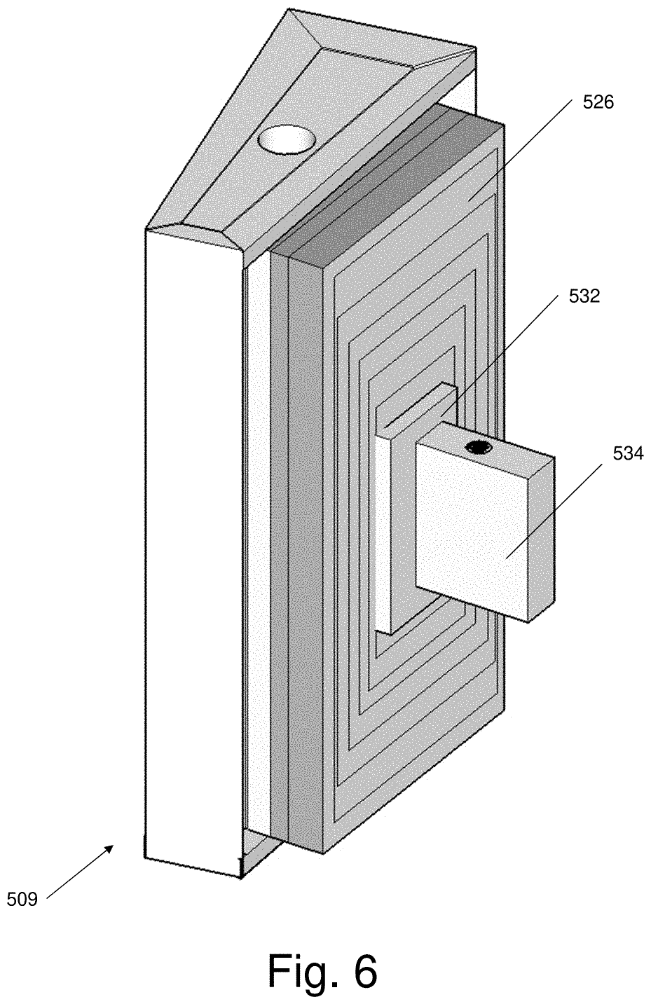

One advantage with forming the coil segment 509 individually is that the conductor wiring or conductors could be bobbin wound on a conventional bobbing spindle using an “off the shelf” commercial machine. FIG. 6 illustrates a coil segment 509 where the conductor wiring or coils 526 has been applied or wound around the projection 532. In certain embodiments, the coils 526 may be wound individually or applied as pre-wound coil units. For example, the coils 526 for an entire phase could be applied on a line. The coil may be wound around or applied to the protrusion 524, come out slightly to make a transition to the next coil in the phase, the adjacent teeth could then be coupled together, and then the next coil wound on the next tooth in the phase. So, the protrusion 532 essentially acts as bobbing spindle or a positioning piece for the coil or coil windings.

In other embodiments, the coil may be a pre-wound unit that is pressed onto the protrusion 524 and electrically connected to the other coils after the entire coil assembly is assembled.

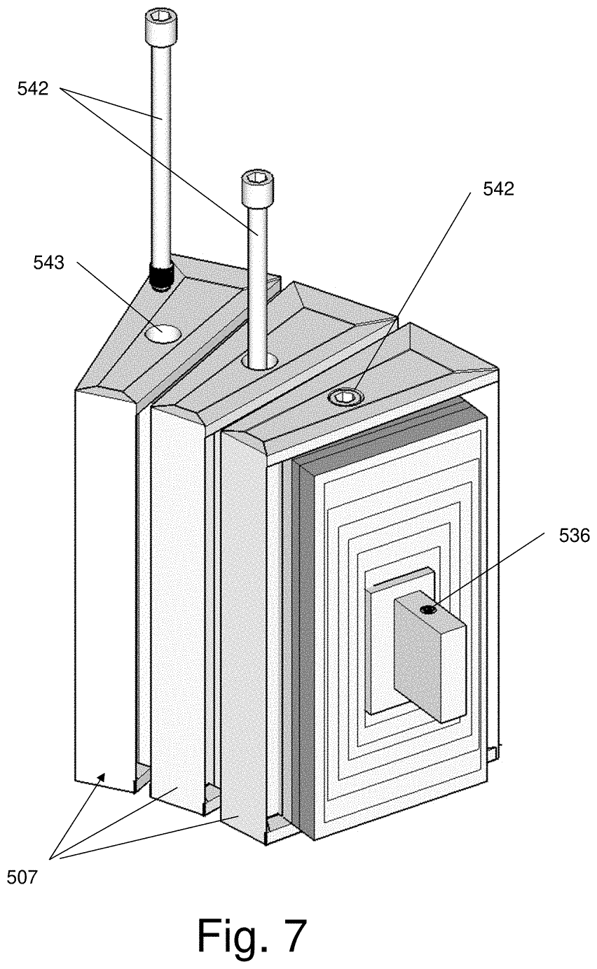

A partial coil assembly 502 is illustrated in FIG. 7, where three adjacent coil segments 509 have been coupled together. In certain embodiments, the coil segments 509 may be secured with fasteners 542 which extend through the adjacent segments and into the screw hole 536 of the respective segment. The fasteners 542 may couple with corresponding holes 543 on a radial or axial face as illustrated in FIG. 7. In yet other embodiments, the holes may be formed on either the inner or outer circumferential face through the exterior fin 520 or the interior fin 522 (refer back to FIG. 4C). The air gaps created by the holes 543 may affect the flux flow in the coil segments 509. In order to minimize the effect of air gap created by the hole in the flux path, an iron or Somaloy pin or screw could be used.

In some embodiments, the air gap created by hole or pin can be used to dissipate heat within the coil assembly—even if the tradeoff is a distribution in the flux path. For instance, an aluminum pin or bolt could be used to transfer heat out of the core or yolk. In other embodiments the pin could be a hollow core pin that is a self-contained heat sink pipe. For instance, if cooling was on one side of the motor, the tube could transfer heat from the hot side to the cooler side and then circulated back to the hot side.

In yet other embodiments, a tapered tube could be used to create a Venturi cooling effect. This may be especially effective where the pins and holes are on the radial or circumferential sides—where centrifugal force can work to expel the air or cooling fluid.

In certain embodiments, the end of the pin may be tapered to assist in pulling the segments together at the correct spacing and angle. In other embodiments, a Dog Point or other self-aligning bolts may be used.

In certain embodiments, the coils 526 may be wound individually or together as a phase. If the coils are wound as an entire phase, the coils 526 may be assembled on a mold, then individual coils can be transferred to adjacent teeth as the assembly process continues. Cooling pipes or additional wiring may be introduced during or after assembly.

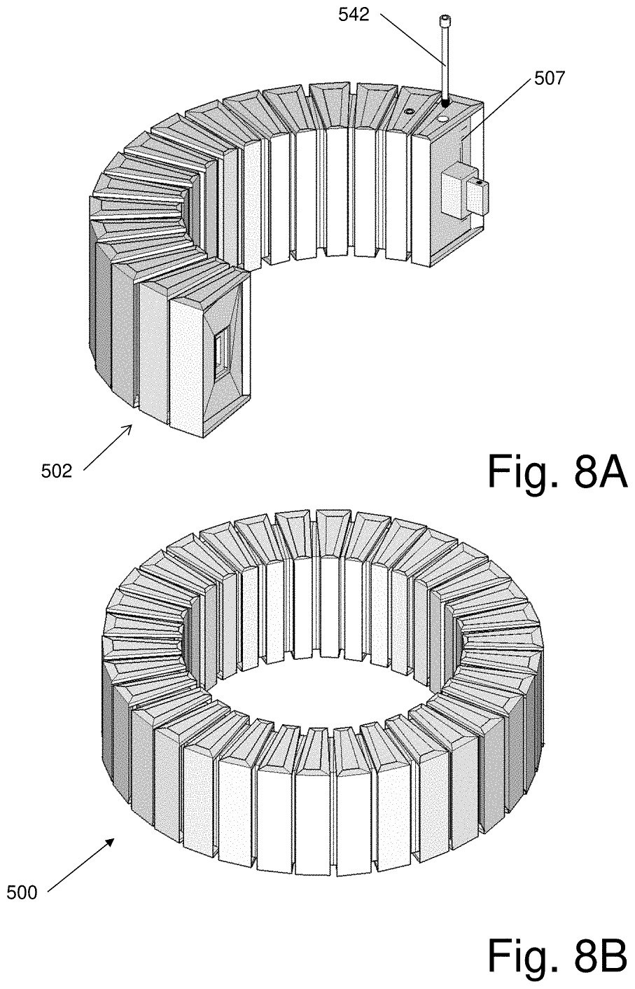

The process of adding more coil segments and coils as illustrated in FIG. 7 can continue as more coil segments 509 and coils 526 are added to make up substantially one half of an entire coil assembly as indicated in FIG. 8A. The process can then repeat for the second half of the coil assembly. Once the second half is completed, the two halves maybe joined together as illustrated in FIG. 8B.

In some embodiments, a rail or external fixture may be used to align the segments 507 during assembly. In yet other embodiments, the segments 509 may be assembled together as indicated in FIGS. 8A and 8B, then a circumferential clamp may be used to apply compression to “pull” the segments together and slightly reduce the diameter of the completed ring assembly. Then the bolts or pins may be added to secure the segments.

In other embodiments, a high temperature epoxy compound or adhesive may be applied to the protrusions of the segments 509 to lock them together and form a single unit as illustrated in FIG. 8B. The epoxy compound does not have a magnetic effect. So, it will create a gap in the magnetic flux path—similar to air. However, a magnetically conductive adhesive could be used to maintain the integrity of the flux path. In order to create a magnetically conductive adhesive, a ferro-magnetic material (or a similar material) powder could be added to the appropriate adhesive.

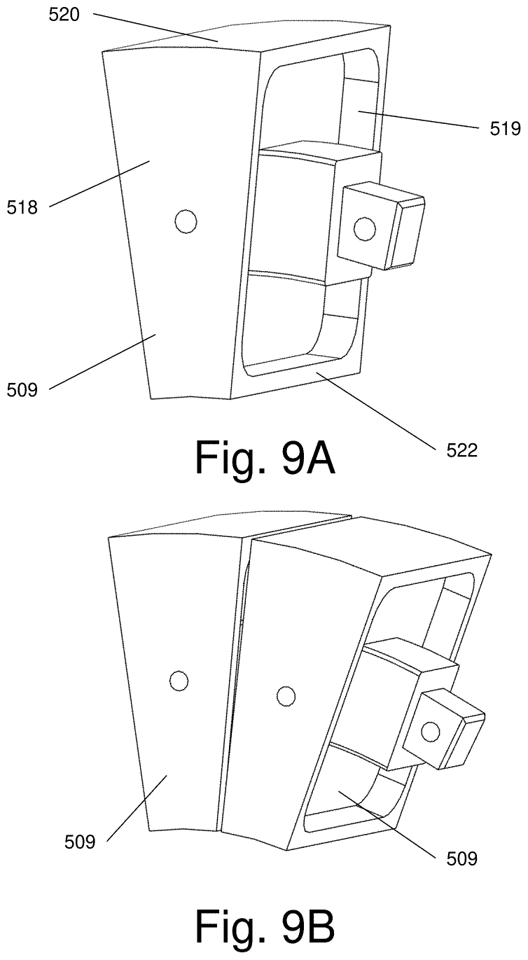

FIG. 9A is a top perspective view of a slightly different embodiment of a single coil segment 509. In this embodiment, the top radial fin 518, the bottom radial fin 519, the exterior fin 520 and the interior fin 522 are substantially wider and more massive than the embodiment illustrated in FIGS. 5A and 5B. FIG. 9B is a top perspective view of two coil segments 509 positioned adjacent to each other.

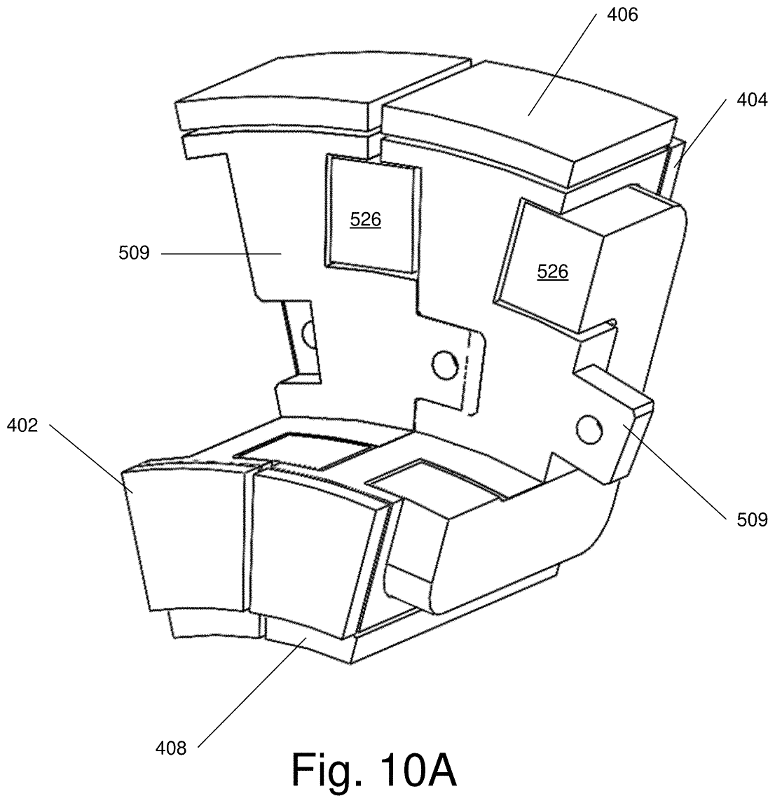

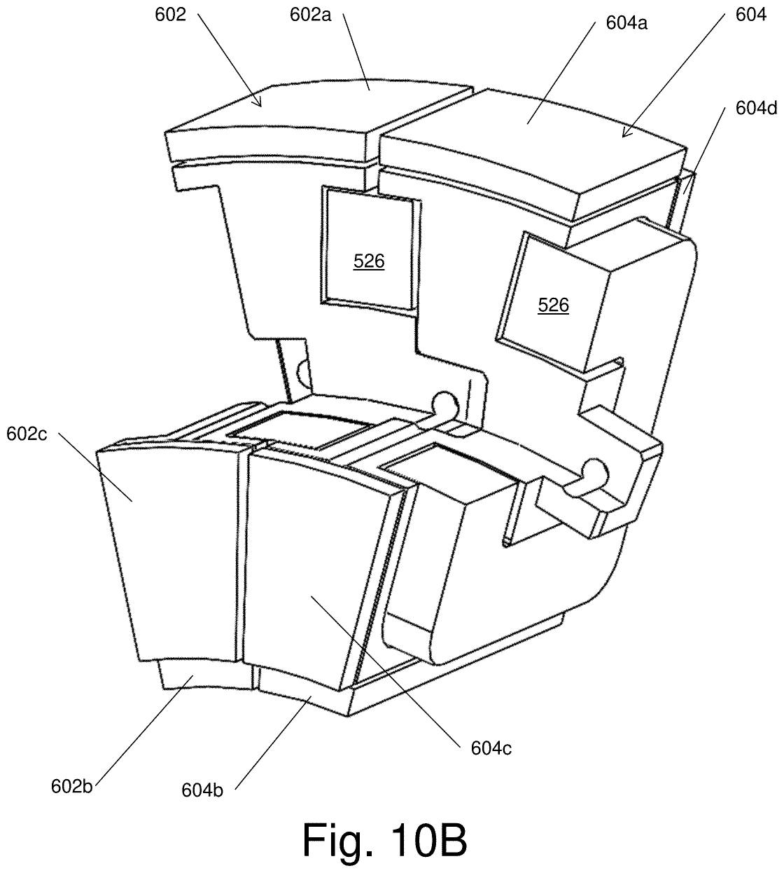

FIG. 10A is a partial section view of the coil segments 509 illustrated in FIG. 9B with the addition of coil windings 526 and magnets or magnetic walls of the magnetic disc assembly 400. FIG. 10B is a partial section view of the coil segments 509 illustrated in FIG. 9B and FIG. 10A, but the section in FIG. 10B is cut at a different location to show additional details of the interaction of the two coil segments 509 and the coil windings 526.

As can be seen in FIGS. 10A and 10B, the coil segments 509 and the coil windings 526 are enclosed by the exterior magnetic wall 406, the interior magnetic wall 408, the first axial wall 402, and the second axial wall 404 forming a magnetic tunnel. The magnetic tunnel is made of radial magnetic tunnel segments as illustrated in FIG. 2. The magnets in each magnetic tunnel segment are orientated in a NNNN configuration which means that all like poles (north or south poles) face either inward or outward for each magnetic wall segment. For instance, there are two magnetic tunnel segments 602 and 604 illustrated in FIGS. 10A and 10B. In certain embodiments, the magnetic tunnel segment 602 includes portions of the magnetic walls discussed above. Specifically, in the illustrated embodiment, the magnetic tunnel segment 602 includes an exterior magnet 602a, an interior magnet 602b, a first axial magnet 602c, and a second axial magnet 602d (not visible) as shown in FIG. 10B. Similarly, the magnetic tunnel segment 604 includes an exterior magnet 604a, an interior magnet 604b, a first axial magnet 604c, and a second axial magnet 604d as shown in FIG. 10B.

In the illustrative embodiment of FIG. 10B, the magnetic tunnel segment 602 would have an opposite magnetic orientation than the magnetic tunnel segment 604. For instance, if the magnets 602a to 602d all had their south poles facing inward, the magnets 604a to 604d would all have their north poles facing inward. Also note that in this illustrative embodiment, the width of the fins of the coil segments 509 generally correspond to the width of the magnets 604a-604d or 602a-602d.

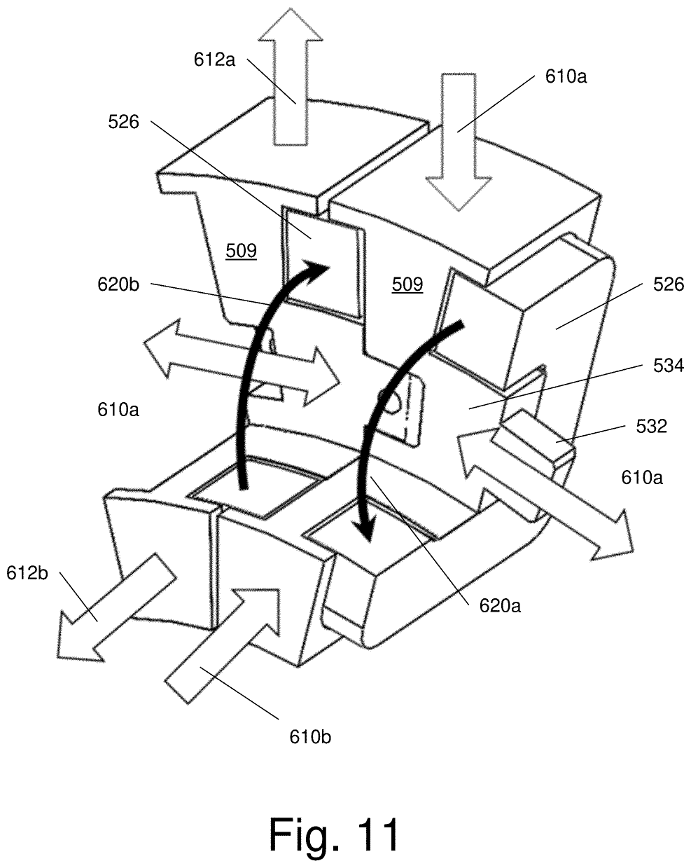

The coil segment/magnetic tunnel segment configuration illustrated in FIG. 10A and FIG. 10B causes a three-dimensional flux path to be created as illustrated in FIG. 11. In FIG. 11, the arrow 610a represents the magnetic flux from the magnet 604a (see FIG. 10B). The arrow 610b represents the magnetic flux from magnet 604b (see FIG. 10B). The direction of the current in the coil windings 526 is illustrated by the black arrows 620a and 620b.

Thus, when the current in the coil windings 526 flow as illustrated, the flux path flows inward from the magnetic tunnel segment 604 (represented by arrows 610a and 610b) through the sides of coil segment 509 down into the yoke or core portions (protrusions 532 and 534) where the flux then flows to the adjacent coil segment protrusions 532 and 534 and then outward through the sides of the coil segment 509 to the south magnetic poles of the magnets in the adjacent tunnel segment as represented by arrows 612a and 612b. Thus, producing a three-dimensional flux path in each coil segment 509.

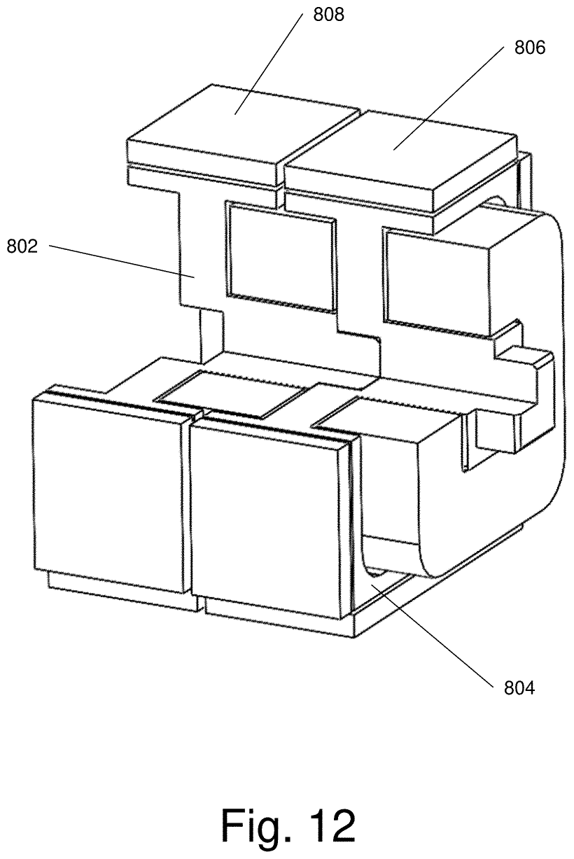

Although the illustrative embodiment is shown in reference to a rotary motor, the same principles and methods of manufacturing can also apply to a pole segment for a linear motor. Two adjacent pole segments 802 and 804 and the surrounding magnet tunnel segments 806 and 808 for a linear motor are illustrated in FIG. 12.

The foregoing description of the embodiments of the invention has been presented for the purposes of illustration and description. It is not intended to be exhaustive or to limit the invention to the precise form disclosed. Many combinations, modifications and variations are possible in light of the above teaching. For instance, in certain embodiments, each of the above described components and features may be individually or sequentially combined with other components or features and still be within the scope of the present invention. Undescribed embodiments which have interchanged components are still within the scope of the present invention. It is intended that the scope of the invention be limited not by this detailed description, but rather by the claims or future claims supported by the disclosure.

What is claimed is:

1. A method of producing a coil assembly comprising:
forming a plurality of coil segments, wherein each coil segment in the plurality of coil segments is formed by:
pressing a powdered metal into a mold to form a coil segment which has a first fin, a second fin, a third fin, a fourth fin, and a center core protrusion, and
treating the coil segment to hardened and strengthen the coil segment;
applying a first conductor winding to a portion of the center core protrusion of a first coil segment of the plurality of coil segments,
coupling the first coil segment to a second coil segment of the plurality of coil segments,
applying a second conductor winding around at least a portion of the center core protrusion of the second coil segment,
repeating the applying, coupling, and applying steps until one half of the coil assembly has been assembled,
repeating the applying, coupling, and applying steps until a second half of the coil assembly has been assembled, and
joining the first half of the coil assembly to the second half of the coil assembly to form the coil assembly.

2. The method of claim 1, wherein the powdered metal has resin coatings on substantially each particle and the treating includes heat treating the coil segment in a nitrogen steam environment which causes the resin coatings of the powdered metal to be oxygenated together.

3. The method of claim 1, wherein the powdered metal is mixed with a low melting point epoxy and the treating includes heating to lower the viscosity of the epoxy so that the epoxy can be easily removed through the mold.

4. The method of claim 1, wherein the applying the first conductor winding includes pressing a pre-wound modular coil unit onto the center core protrusion.

5. The method of claim 1, further comprising forming a connection hole within the coil segment.

6. The method of claim 5, wherein the connection hole is formed with a sacrificial rod having a low melting point and removing the sacrificial rod by heating the coil assembly above the low melting point.

7. The method of claim 1, wherein the coupling includes extending a rod through connection holes of the first coil segment and the second coil segment to join the first coil segment to the second coil segment.

8. The method of claim 1, wherein the coupling includes using an epoxy to join the first protrusion to an interior of the second protrusion.

9. The method of claim 8, wherein the coupling includes mixing a ferro-magnetic material to the epoxy before using the epoxy to join the first protrusion to the second protrusion.

10. An electric machine comprising:
a toroidal magnetic tunnel comprising a plurality of radial magnetic tunnel segments wherein each magnetic tunnel segment has at least four magnets with their magnetic poles facing towards an interior of the magnetic tunnel segment and a magnetic pole configuration of the magnetic tunnel segment is an NNNN magnetic pole configuration and wherein the magnetic pole configuration of an adjacent magnetic tunnel segment is a SSSS magnetic pole configuration;
a coil assembly sized to fit within the toroidal magnetic tunnel wherein the coil assembly comprises a plurality of coil segments, wherein each coil segment in the plurality of coil segments has four fins for magnetically interacting with the four magnets of the magnetic tunnel segment;
a plurality of coil windings where each coil segment has a coil winding coupled to a corresponding coil segment; and
a connecting means for joining adjacent coil segments together.

11. The electric machine of claim 10, wherein each coil segment is formed from powdered metal.

12. The electric machine of claim 10, wherein each coil segment is forged.

13. The electric machine of claim 10, wherein the connecting means is a rod formed from powdered metal.

14. The electric machine of claim 10, wherein the connecting means is a rod formed from a heat conducting material to create a heat pipe.

15. The electric machine of claim 10, wherein the connecting means is a hollow rod.

16. The electric machine of claim 10, wherein the connecting means is a rod with a tapered end to assist in aligning and joining the coil segments together.

17. The electric machine of claim 10, wherein the connecting means is a tapered rod to provide a venturi cooling effect within the coil segment.

18. The electric machine of claim 10, wherein the connecting means is a self-contained heat sink pipe for a one way transfer of heat.

19. The electric machine of claim 10, wherein the connecting means is an epoxy fused with a ferro-magnetic material.
